(19) United States
(12) Patent Application Publication
(10) Pub. No.: US 2009/0176148 A1
(43) Pub. Date: Jul. 9, 2009

(54) THERMAL MANAGEMENT OF ELECTROCHEMICAL CELLS

(75) Inventors: Junwei Jiang, Woodbury, MN (US); Douglas C. Magnuson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/969,491

(22) Filed: Jan. 4, 2008

(51) Int. Cl. H01M 10/50; H01M 10/44

(52) U.S. Cl. 429/120; 320/127

(57) ABSTRACT

Provided are systems and methods that generally relate to passive dual-phase thermal management for rechargeable electrochemical cells. The provided systems and methods can include a nonaqueous heat-transfer medium such as a fluorinated carbon fluid. Fluorinated carbon fluids such hydrofluoroethers can be useful in the provided systems.

### FIELD

Provided are systems and methods that generally relate to passive dual-phase thermal management for rechargeable electrochemical cells that include fluorinated carbon fluids.

### BACKGROUND

Conventional rechargeable electrochemical cells generate a controlled amount of heat under normal operating conditions. These cells, however, are subject to an occasional rapid increase in, and release of, heat due to various factors. The increase and release of heat may occur due to an external cause, such as a short circuit applied to the cell terminals, physical damage to the cell, or an internal defect inside of the cell. When an electrochemical cell experiences such a rapid increase in heat release, the cell can go into a sudden mode that causes cell failure. Although such rapid increases and releases of heat may be relatively rare, if the release of heat occurs in a bank or battery of electrochemical cells, the release of heat from one cell can be sufficient to cause the other surrounding cells to reach their thermal runaway point resulting in a chain reaction.

### SUMMARY

Lithium-ion electrochemical cells are increasingly being used in electronic devices such as laptop computers, cellular telephones, and cordless power tools, and are being considered as power sources for vehicles. Lithium-ion cells are of interest because of their high energy density potential, excellent lifetime, and rechargeability. There is a need for thermal management systems for electrochemical cells, especially lithium-ion electrochemical cells. There is a need to have thermal management systems that do not require complex hardware, such as pumps or valves and complicated sealing. Additionally there is a need to have thermal management systems for electrochemical cells that can act to cool down cells in thermal runaway conditions and/or to extinguish any fires that might be produced during runaway. Further, there is a need for low cost, portable thermal management systems that can dissipate a lot of heat quickly.

In one aspect, provided is a passive thermal management system for electrochemical cells that includes a nonaqueous heat-transfer medium, a container having an inside and an outside, wherein the inside holds the heat-transfer medium, and at least one or more electrochemical cells at least partially immersed in the medium.

In another aspect, provided is a thermal management system that includes a heat-transfer fluid, one or more electrochemical cells, and a heat exchanger at least partially filled with the heat-transfer fluid, wherein the one or more cells are in thermal contact with the heat exchanger.

Finally provided is a method for passive thermal management of electrochemical cells that includes providing a container filled with a thermal transfer medium, partially immersing at least one electrochemical cell in the medium, charging or discharging the cell to produce a heated cell, transferring the heat from the heated cell to the medium, and the removing heat from the heated cell by vaporization of the medium.

In this Document:

“a”, “an”, and “the” are used interchangeably with “at least one” to mean one or more of the elements being described;

“alloy” refers to a hybrid of two or more elements, at least one of which is a metal, and where the resulting material has metallic properties;

“charge” and “charging” refer to a process for providing electrochemical energy to a cell;

“delithiate” and “delithiation” refer to a process for removing lithium from an electrode material;

“discharge” and “discharging” refer to a process for removing electrochemical energy from a cell, e.g., when using the cell to perform desired work; and “metal” refers to both metals and to metalloids such as silicon, and carbon, whether in an elemental or ionic state.

The provided thermal management system for electrochemical cells can be passive, i.e. it does not include pumps but can circulate coolant by convection. Heat-transfer media, such as hydrofluoroethers, that have a high thermal conductivity can be used in the provided systems. They can carry off heat generated by the electrochemical cells by conducting heat from the cells to a container that holds the media. Additionally, they can absorb heat generated by the cells by vaporizing at the surface of the cells and then condensing on the surface of the container to remove heat. Also, by employing a heat-transfer medium that does not support combustion, the provided thermal management system can prevent or extinguish fires that otherwise may result from thermal runaway events.

The above summary is not intended to describe each disclosed embodiment of every implementation of the present invention. The brief description of the drawings and the detailed description which follows more particularly exemplify illustrative embodiments.

### BRIEF DESCRIPTION OF THE DRAWINGS

FIG. 1 is a schematic of an embodiment of a thermal management system that includes an array of electrochemical cells immersed in a thermal transfer medium.

FIG. 2 is a schematic of an embodiment of a thermal management system that includes an array of electrochemical cells in contact with a heat exchanger.

FIG. 3A is a cross-sectional view of an embodiment of a thermal management system that includes an array of electrochemical cells in a container that is at least partially immersed in a thermal transfer medium.

FIG. 3B is an exploded view of the embodiment of FIG. 3A that shows a thermal management system including a heat exchanger.

FIGS. 4A and 4B are graphs of performance characteristics of a control (FIG. 4A) and of one embodiment of a provided thermal management system (FIG. 4B).

FIGS. 5A and 5B are graphs of performance characteristics of another control (FIG. 5A) and of another embodiment (FIG. 5B) of a provided thermal management system.

FIG. 6 is a graph of performance characteristics of yet another embodiment of the provided thermal management system.

### DETAILED DESCRIPTION

The provided thermal management system for lithium-ion electrochemical cells is a passive system. By passive it is meant that there are no pumps that use or need mechanical or electrical energy in the system. In a passive system, such as the provided system, movement of a thermal transfer medium (otherwise referred to as a coolant) can occur by convection. The use of a passive thermal management system allows for the avoidance of complex hardware such as pumps and valves in the system. The provided system can remove excess heat generated by the lithium-ion cells (during lithiation or discharging) through thermal convection of the heat from the cells to the thermal transfer medium and transfer of heat from the thermal transfer medium to the surface of the container. The provided system can also remove excess heat by at least partially vaporizing the thermal transfer medium at locations where the thermal transfer medium contacts the cells. The heated vapor of the thermal transfer medium can then move to the surface of a heat exchanger (that can also be the surface of the container), transfer heat to the heat exchanger, condense, and then reflow into the thermal transfer medium reservoir. In this manner, the extra heat can be removed by convection and by using the heat of vaporization of the medium.

The provided system can include a nonaqueous heat-transfer medium. The heat-transfer medium can be a liquid. Exemplary nonaqueous heat-transfer liquids that can be used include perfluorocarbons (PFCs), perfluoropolyethers (PFPEs), perfluoroamines (PFAs), perfluoroethers (PFEs), silicone oils and hydrocarbon oils. PFCs, PFPEs, PFAs and PFEs may exhibit atmospheric lifetime values of greater than 500 years, and up to 5,000 years. Additionally, these materials may exhibit high global warming potentials (“GWP”). GWP is the integrated potential warming due to the release of one (1) kilogram of sample compound relative to the warming due to one (1) kilogram of CO₂ over a specified integration time horizon. Additionally silicone oils and hydrocarbon oils can be flammable.

The provided thermal management system for electrochemical cells can include a nonflammable, inert, nonaqueous thermal transfer medium. By nonflammable it is meant that the medium does not easily support combustion especially under the conditions of runaway thermal events. By inert it is meant that under normal operating conditions of the cell, the medium does not substantially react with the components of the cell. For heat-transfer processing requiring an inert fluid, fluorinated carbon fluids can be used. Fluorinated carbon fluids typically have low toxicity, are essentially non-irritating to the skin, are non-chemically reactive, are non-flammable, and have high dielectric strength. Fluorinated carbon fluids such as perfluorocarbons, perfluoroketones, perfluoropolyethers, hydrofluoroethers, and can provide the additional advantage of not depleting the ozone layer in the stratosphere.

In some embodiments the provided thermal management system includes a hydrofluoroether heat-transfer fluid (or a mixture of hydrofluoroether heat-transfer fluids) that is inert, has high dielectric strength, low electrical conductivity, chemical inertness, thermal stability and effective heat transfer. Additionally, the provided system comprises a heat-transfer fluid that is liquid, and has good heat transfer properties over a wide temperature range. Exemplary hydrofluoroethers that can be useful in embodiments of the provided system include compounds represented by the following structure:

R¹_{f}—O—Rₕ—O—R¹_{f}′

wherein, O is oxygen; R¹_{f} and R¹_{f}′ are, independently, a fluoroaliphatic group, wherein each R¹_{f} and R¹_{f}′ contain at least 1 hydrogen atom; Rₕ is a linear, branched or cyclic alkylene group having from 2 to about 8 carbon atoms and at least 4 hydrogen atoms, wherein Rₕ can contain one or more catenated heteroatoms, and wherein the hydrofluoroether compound is free of —O—CH₂—O—. Hydrofluoroether compounds of this structure are disclosed, for example, in U.S. Pat. Nos. 6,953,082; 7,055,579; and 7,128,133 (all Costello et al.) and U.S. Pat. Publ. No. 2007/0018134 (Costello et al.).

Other hydrofluoroether compounds useful in some embodiments of the provided system include cyclic hydrofluoroether compounds such as those disclosed in U.S. Pat. Publ. Nos. 2007/0267464 (Vitcat et al.). These compounds can be represented by the general formulas (I) and (II):

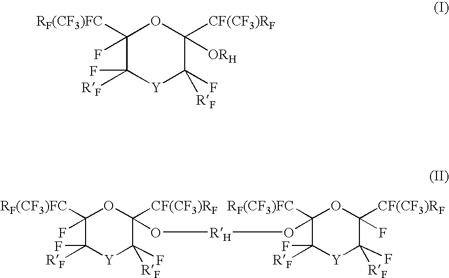

wherein each R_{F} is independently a linear or branched perfluoroalkyl group that optionally contains at least one catenated heteroatom selected from divalent ether oxygen atoms and trivalent nitrogen atoms and that optionally comprises a terminal moiety selected from —CF₂H, —CFHCF₃, and —CF₂OCH₃ (preferably, a linear or branched perfluoroalkyl group that has from one to about six carbon atoms and that optionally contains at least one catenated heteroatom selected from divalent ether oxygen atoms and trivalent nitrogen atoms; more preferably, a linear or branched perfluoroalkyl group that has from one to about three carbon atoms and that optionally contains at least one catenated divalent ether oxygen atom; most preferably, a perfluoromethyl group); each R_{F}′ is independently a fluorine atom or a perfluoroalkyl group that is linear or branched and that optionally contains at least one catenated heteroatom (preferably, having from one to about four carbon atoms and/or no catenated heteroatoms); Y is a covalent bond, —O—, —CF(R_{F})—, or —N(R_{F}″)—, wherein R_{F}″ is a perfluoroalkyl group that is linear or branched and that optionally contains at least one catenated heteroatom (preferably, having from one to about four carbon atoms and/or no catenated heteroatoms); R_{H}′ is an alkylene or fluoroalkylene group that is linear, branched, cyclic, or a combination thereof, that has at least two carbon atoms, and that optionally contains at least one catenated heteroatom (preferably, linear or branched and/or having from two to about eight carbon atoms and/or having at least four hydrogen atoms and/or no catenated heteroatoms).

In other embodiments the thermal management system can include fluorochemical ketone compounds such as those disclosed in U.S. Pat. Publ. No. 2007/01633710 (Costello et al.). These fluorochemical ketone compounds can be represented by the following general formula (III):

R²_{f}′—C(═O)—[CF₂—O—(CF₂CF₂O)ₘ—(CF₂O)ₙ—CF₂]—C(═O)—R²_{f}″ (III)

wherein R²_{f}′ and R²_{f}″ are each independently a branched perfluoroalkyl group that optionally contains at least one catenated heteroatom and that optionally comprises a terminal moiety selected from —CF₂H, —CFHCF₃, and —CF₂OCH₃; m is an integer of one to about 100; n is an integer of zero to about 100; and the tetrafluoroethyleneoxy (—CF₂CF₂O—) and difluoromethyleneoxy (—CF₂O—) moieties are randomly or non-randomly distributed. Preferably, R²f′ and R²_{f}″ are each independently branched perfluoroalkyl groups that optionally contain at least one catenated heteroatom (more preferably, branched perfluoroalkyl groups having from about 3 to about 6 carbon atoms); m is an integer of one to about 25 (more preferably, one to about 15); and n is an integer of zero to about 25 (more preferably, zero to about 15).

Other hydrofluoroether compounds useful in embodiments of the provided system include fluorinated ethers of the formula, R³_{f}—O—R³_{f}′, where R³_{f} and R³_{f}′ are the same or different and are selected from the group consisting of substituted and nonsubstituted alkyl, aryl, and alkylaryl groups and their derivatives. At least one of R³_{f} and R³_{f}′ contains at least one fluorine atom, and at least one of R³_{f} and R³_{f}′ contains at least one hydrogen atom. Optionally, one or both of R³_{f} and R³_{f}′ may contain one or more catenated or noncatenated heteroatoms, such as nitrogen, oxygen, or sulfur, and/or one or more halogen atoms, including chlorine, bromine, or iodine. R³_{f} and R³_{f}′ may also optionally contain one or more functional groups, including carbonyl, carboxyl, thio, amino, amide, ester, ether, hydroxy, and mercaptan groups. R³_{f} and R³_{f}′ may also be linear, branched, or cyclic alkyl groups, and may contain one or more unsaturated carbon-carbon bonds. These materials are disclosed in U.S. Pat. No. 5,713,211 (Sherwood), and U.S. Pat. No. 7,208,100 (Minor et al.). Hydrofluoroethers having at least one hydrogenated —OCFX′CH₃ endgroups where X′ is F or CF₃, are also useful in embodiments of this system. These materials are disclosed, for example, in U.S. Pat. Publ. No. 2007/0106092 (Picozzi et al.). All of the above are herein incorporated by reference.

The heat-transfer medium of some embodiments of provided thermal management systems can have a low boiling point. For example, the medium can have a boiling point of less than 80° C., less than 70° C., less than 60° C., or even less than 50° C.

The heat-transfer medium of other embodiments of provided thermal management systems can be held within (inside of) a container. The container can be of any size or shape and can be made of a material that has good thermal transfer properties. The container can be large enough to allow electrochemical cells to be placed completely inside of it. The container can be made of metal, a metal alloy, a composite, a polymer or copolymer, or any material that can contain the fluid, have good thermal transfer properties, and does not interfere with the performance of an electrochemical cell placed within. Examples of useful materials include metals such as nickel, stainless steel, and copper; glasses, including thermally conductive glasses. Useful polymers or copolymers can include polyolefins, polyesters, polyimides, polycarbonates, nylons, polystyrenes, epoxies, copolymers of the foregoing, and combinations thereof. Polyolefins, such as polyethylene or polypropylene or copolymers thereof are particularly useful. Composites of polymers and/or ceramics that include thermally conductive materials such as metallic nanoparticles, carbon nanotubes, nanowires, and other additives that impart thermal conductivity to the composite are also contemplated for use as containers in the provided thermal management system.

The inside of the container can hold a heat-transfer medium. The container can be at least partially filled with the heat-transfer medium. In some embodiments, the container can be open at the top or it can be essentially closed. By essentially closed it is meant that the container can be enclosed with a top (located above the fluid level) that includes at least one small vent. In embodiments where the container is essentially closed and the heat-transfer medium is a liquid, especially a low boiling liquid, the container can have a space for a vapor phase over the liquid. The vent can be a pressure relief system that can include a small opening or another device, such as a valve that allows the pressure of the vapor inside of the container (and over the liquid) to stay at substantially atmospheric pressure.

The provided thermal management system can have at least one electrochemical cell at least partially immersed in the thermal transfer medium. In some embodiments, the cell can be completely immersed in the medium. In some embodiments, the at least one cell is a part of a battery pack that has multiple cells. In this case, at least one cell included in the battery pack is at least partially immersed in the medium. To effectively control the temperature of the electrochemical cell, the cell can be immersed in the medium so that heat is transferred from the cell to the medium in enough quantity to allow the cell or the battery pack of cells to maintain a proper operating temperature. In some embodiments it is preferred that the cells be completely immersed in the medium. In other embodiments it is preferred that the cells be about halfway immersed in the medium. In other embodiments, proper temperature control can be achieved with less immersion.

Heat can be transferred from the electrochemical cell in the provided thermal management system to the thermal transfer medium. In some embodiments heat can be directly transferred through convection from the surface of the electrochemical cell to the medium. In other embodiments heat can be transferred to the medium by causing at least some of the heat-transfer medium to undergo a phase change from liquid to vapor. In this manner, heat is transferred from the cell into the energy required to vaporize the heat-transfer medium. In many embodiments both convection and vaporization can transfer heat from the cells.

In some embodiments, the container can have a surface, or a part of a surface that can act as a condensing surface. This surface can have a high thermal transfer coefficient and can remove heat from the vapor allowing the vapor to transfer heat to the surface and condense back into the reservoir of thermal transfer medium. In other embodiments, it is contemplated that a separate condenser can be a part of a container. The separate condenser can be a surface that is specially designed to remove heat from vapors. In some embodiments a heat-transfer manifold can be external to the container but can function to condense heated vapor and remove heat from the thermal management system.

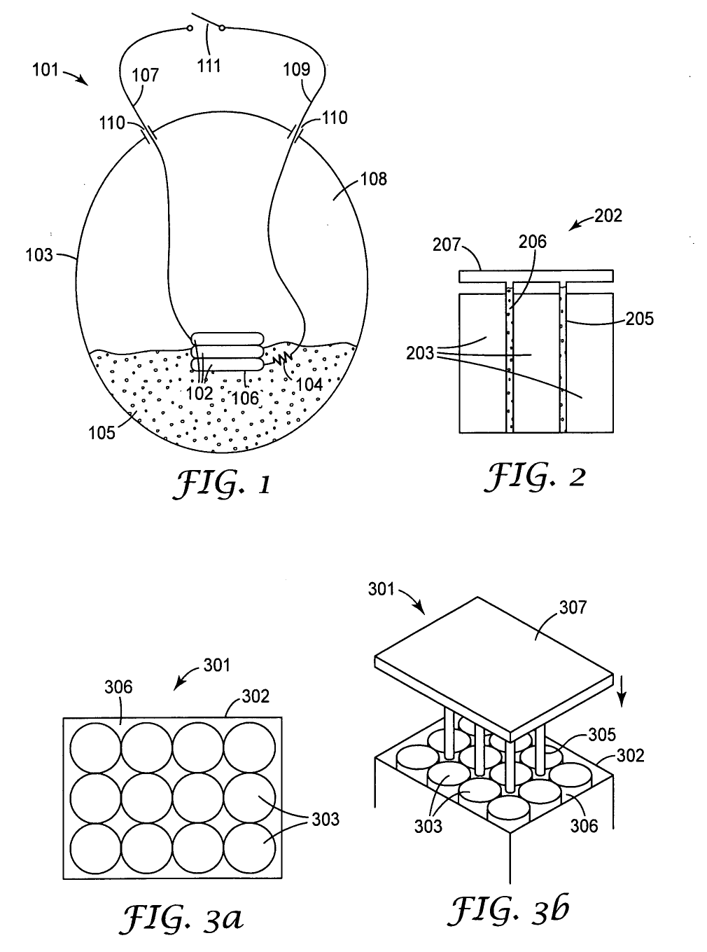

FIG. 1 is a schematic of an embodiment of a thermal management system 101 that includes an array of electrochemical cells 106 (e.g., a battery pack) at least partially immersed in a thermal transfer medium 105. The thermal management system of this embodiment includes container 103 that holds thermal transfer medium 105. An array of electrochemical cells 106 that is made from several electrochemical cells 102 is immersed in heat-transfer medium 105. An ohmic resistor 104 is connected with the battery pack to simulate the heat source. One switch 111 is connected outside of the container to control the circuit. Electrical leads 107 and 109 electrically connect to the anode and the cathode of the array of electrochemical cells 106 respectively. In this embodiment, electrical leads 107 and 109 pass through vent holes 110 that are designed to allow the leads to pass though the container for use outside of the container to power devices such as a cell phone, a computer, an electric vehicle, or any other device that needs portable electricity. Vent holes 110 also allow the vapor 108 over thermal transfer medium 105 inside of container 103 to be substantially at atmospheric pressure.

In another aspect, provided is a thermal management system for electrochemical cells that includes a heat-transfer medium that comprising one or more hydrofluoroethers, a container holding the heat-transfer medium, and one or more electrochemical cells at least partially immersed in the medium. The electrochemical cells can be secondary electrochemical cells. Secondary electrochemical cells can be capable of reversibly charging and discharging multiple times without significant drop in their capacity. Secondary electrochemical cells can include, for example, lithium-ion cells, nickel hydride cells, nickel cadmium cells, alkaline manganese cells, and sealed lead acid cells.

In this aspect, the provided thermal management system can include a heat-transfer medium that includes one or more hydrofluoroethers (HFEs). HFEs are available, for example, under the trade designation NOVEC Engineered Fluids (available from 3M Company, St. Paul, Minn.) or VERTREL Specialty Fluids (available from DuPont, Wilmington, Del.). Particularly useful HFEs for embodiments of the provided systems include NOVEC 7100, NOVEC 7200, NOVEC 71IPA, NOVEC 71DE, NOVEC 71DA, NOVEC 72DE, and NOVEC 72DA, all available from 3M. HFEs can are available as pure compounds or as azeotropic mixtures. In some embodiments the HFEs can be mixed to provide custom properties to the end user. The provided thermal management system can include any of the features of and of the embodiments described above. For example, the hydrofluoroethers can have a boiling point of less than 80° C., less than 70° C., less than 60° C., or even less than 50° C. The container can be open at the top or it can be essentially closed and, if enclosed with a top, can include at least one small vent. The electrochemical cells can be partially or completely submerged in the heat-transfer medium and the system can further include a condenser.

In yet another aspect, provided is a heat-transfer fluid, one or more electrochemical cells, and a heat exchanger at least partially filled with the heat-transfer fluid, wherein the one or more cells are in thermal contact with the heat exchanger. Embodiments of thermal management systems of this aspect can include a heat exchanger at least partially filled with the heat-transfer fluid. The fluid can be any gas or liquid that has good heat capacity and thermal conductivity. The fluid can be in a closed system that is physically and/or chemically isolated from the electrochemical cells. Contemplated fluids can include liquids with high heat capacities, for example, water, glycols, perfluorocarbons (PFCs), perfluoropolyethers (PFPEs), perfluoroamines (PFAs), perfluoroethers (PFEs), silicone oils, and hydrocarbon oils. The system of this embodiment can also include one or more electrochemical cells that are in thermal contact with the heat exchanger. By thermal contact it is meant that there is a means to conduct heat from the cells to the heat exchanger. This means can include direct contact of the electrochemical cells with the heat exchanger or the use of a thermal transfer medium.

In an alternate embodiment of this aspect, the electrochemical cells can be inside of a container that contains a nonaqueous thermal transfer medium that allows heat generated by the cells to be transported to the heat exchanger. The thermal transfer medium can be nonaqueous and inert to the electrochemical cells that are at least partially immersed therein. The thermal transfer medium can be any of the materials discussed above for the other aspects of the provided thermal management systems. The medium can include hydrofluorocarbons.

This aspect of a provided thermal management system can be further illustrated by reference to FIGS. 2, 3A, and 3B. FIG. 2 is a schematic of an embodiment of a thermal management system 202 that includes an array of electrochemical cells in contact with a heat exchanger. Referring to FIG. 2, provided are three lithium-ion cells 203 that are in direct thermal contact with heat exchanger 205. Heat exchanger 205 contains thermal transfer fluid 206 in a compartment separate from the lithium-ion cells 203. Heat generated by the cells 203 is transferred by direct contact to the heat exchanger 205. The heat is transferred to the thermal transfer fluid 206 inside of the heat exchanger. The heat exchanger 205 is in contact with a heat-transfer manifold 207 that is external or away from the cells. The heated thermal transfer fluid can transfer its heat to the heat-transfer manifold to complete the system. The heat-transfer manifold can be, for example, an external condenser, a convection plate, or a radiator with many fins that can conduct the transferred heat to the surrounding atmosphere.

FIG. 3A is a top-down cut-away view of an embodiment the provided thermal management system 301 that includes lithium-ion electrochemical cells 303 packed inside of a container 302. The cells are surrounded by a heat-transfer medium 306. A heat exchanger (not shown in FIG. 3A) has projections that extend downward though the heat-transfer medium between each of the cells. The heat exchanger is in thermal contact with heat-transfer manifold 307. FIG. 3B shows another view of the same thermal management system 301 that includes lithium-ion cells 303 in container 302 at least partially submerged in thermal transfer medium 306. Also shown is an exploded view of heat exchanger 307 that includes a number of hollow projections of heat exchanger 305 that are in thermal contact with heat-transfer manifold 307. Projections 305 extend into heat-transfer medium 306 to cool the cells. Heat exchanger can contain a heat-transfer fluid in a closed system separate from the heat-transfer medium in the container.

In yet another aspect, provided is a method for passive thermal management of electrochemical cells that includes providing a container filled with a thermal transfer medium, partially immersing at least one electrochemical cell in the medium, charging or discharging the cell to produce a heated cell, transferring the heat from the heated cell to the medium, and the removing heat from the heated cell by vaporization of the medium. As is the case in the embodiments of a thermal management system, the thermal transfer medium can include a nonflammable, inert, nonaqueous thermal transfer medium. Fluorinated carbon fluids can be used. In some embodiments, fluorinated carbon fluids such as perfluorocarbons, perfluoropolyethers, and hydrofluoroethers are preferred. Other preferred embodiments can include a thermal transfer medium that has a boiling point of less than 80° C., less than 70° C., less than 60° C., or even less than 50° C.

The provided method can further comprise the step of condensing the medium to form condensed medium. In some embodiments, the condensing can occur on the sides of the container wherein the heat from the vaporized medium is transferred to the walls of the container where it condenses. Alternatively, the condensing can occur, for example, on the surface of an external condenser, a convection plate, or a radiator with many fins that can conduct the transferred heat to the surrounding atmosphere. In some embodiments, the condensing surface can be located external to, but in thermal contact with, the thermal management system. In these embodiments conduits can be included to conduct the thermal transfer medium to the external condenser. In many embodiments, the method further comprises returning the condensed medium to the thermal transfer medium in the container. In this way the thermal transfer medium acts as a conduit to transfer heat from the electrochemical cell or cells to the atmosphere.

A number of embodiments of the invention have been described. Nevertheless, it will be understood that various modifications can be made without departing from the spirit and scope of the invention. Accordingly, other embodiments are within the scope of the following claims.

### EXAMPLES

### Example 1

### Heat Transfer in a Liquid Medium (3.3V Lithium-Ion Cell with a 2 Ohm Resistor)

The experiment in Example 1 was similar to Comparative Example 1 except that a heat-transfer medium was placed in the container. NOVEC 71IPA Engineered Fluid, (about 95 wt % C₄F₉OCH₃ and 5 wt % isopropanol) available from 3M Company, St. Paul, Minn. and which has a boiling point of about 54° C., was used for this Example. After the switch was turned on, the cell began discharging and the cell voltage slowly decreased. The cell temperature was maintained at around 30° C. The resistor temperature started from around 27° C. and quickly increased above 33° C. within 20 seconds. The final resistor temperature stayed around 42° C. and the medium around the resistor was boiling and condensing on the container surface.

### Comparative Example 1

### Heat Transfer in Air (3.3V Lithium-Ion Cell with a 2 Ohm Resistor)

Five 26650-size (cylindrical cell with 26 mm diameter bottom and 65 mm height) cells available from A123 Systems Inc., Boston, Mass.) were charged to 3.6 V at 0.4 A current. The cathode material in the cell was LiFePO₄ and anode material was carbon. The cell was connected with a 2 ohm resistor, available from Ohmite Mfg. Co., Rolling Meadows, Ill., and a switch. The experiment design was similar to FIG. 1 except there was no heat-transfer medium. The cell voltage, cell temperature, and resistor temperature were recorded by Portable Handheld Datalogger available from Omega Engineering Inc., Stamford, Conn.

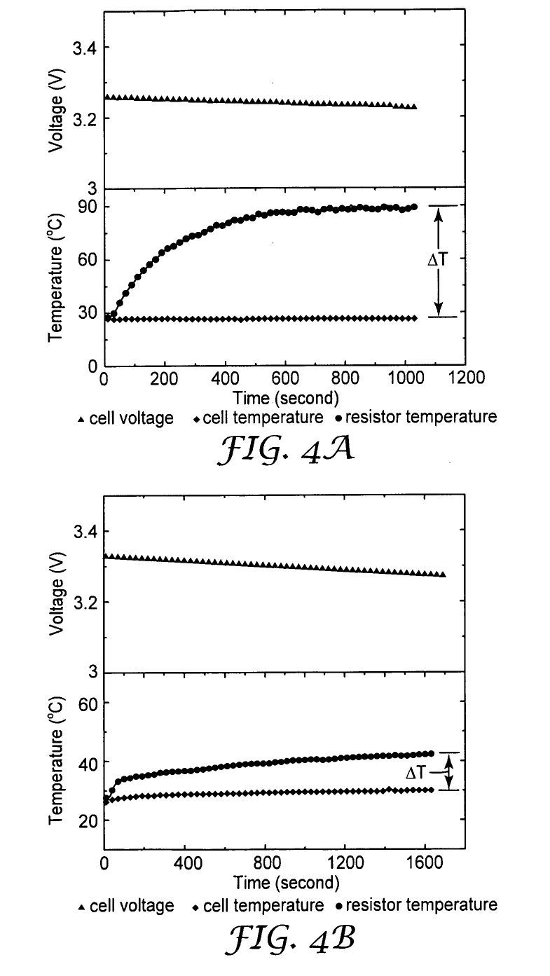

FIG. 4A shows a graph of the cell voltage in “triangle” symbol, the cell temperature in “diamond” symbol, and the resistor temperature in “dot” symbol. The experiment was done in air. After the switch was on, the cell discharged at a rate of approximately 1.65 A and the heat power generated from the resistor was calculated as around 5.4 W. The resistor temperature increased to around 90° C. and the cell temperature stabilized at 27° C. The temperature difference between the cell and resistor was around 63° C.

### Example 2

### Heat Transfer in a Liquid Medium (3.3V Lithium-Ion Cell with a 0.5 ohm Resistor)

The experiment in Example 2 was similar to Comparative Example 2 except that a heat-transfer medium, NOVEC 71IPA was used. When the switch was turned on, the resistor temperature quickly increased into 40° C. within 30 seconds and then gradually increased to 50° C. The heat-transfer medium significantly controlled the temperature rise, compared to the case in Comparative Example 2 where there was no heat-transfer medium and the resistor temperature quickly rose above 160° C.

This is a model for a soft-shorting case for an 18650-size cell. The typical commercial 18650-size cell has an average cell voltage around 3.7 V and a capacity around 2.4 Ah. The electric energy contained in the cell is around 9 Wh. If a soft-shorting happens at a rate of 2 C rate (30 min full discharge), the electric power will be around 18 W. This is close to the case in Example 2, where the heat power from the 0.5 ohm resistor was around 22 W. In both cases, the heat-transfer medium effectively controlled the cell temperature around the boiling point of the medium.

### Comparative Example 2

### Heat Transfer in Air (3.3V Lithium-Ion Cell with a 0.5 Ohm Resistor)

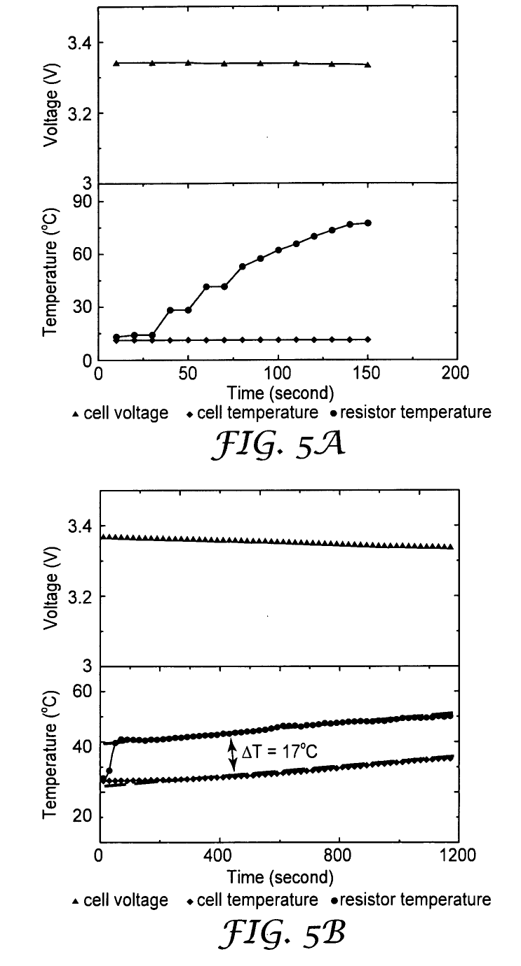

The experiment in Comparative Example 3 was similar to Comparative Example 1 where no heat-transfer medium was present. The heat resistor used in this example was 0.5 ohm instead of 2 ohm and the heat power of the resistor was calculated as around 22 W, which was approximately 4 times of the heating power in Example 1. FIG. 5A shows that the cell temperature in “dot” symbols quickly rose to over 160° C. within 150 seconds when the experiment was stopped.

### Example 3

### Heat Transfer with Double Cell Parallel Connected in Air and a 0.5 Ohm Resistor in the a Liquid Medium

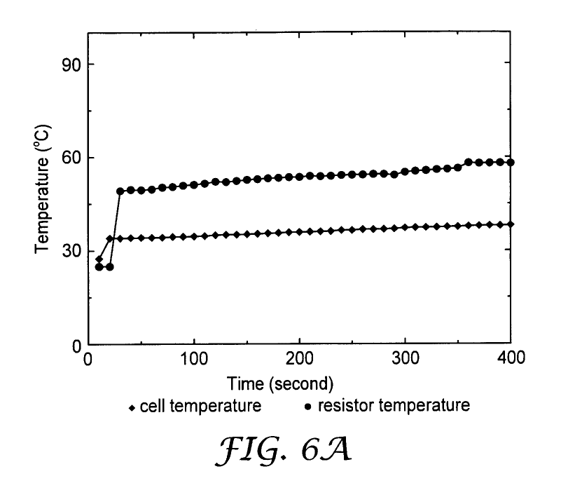

Two fully charged 26650-size cells (A123 Systems Inc.) were connected in parallel to deliver an average voltage of approximately 6.6 V to simulate a battery pack. The battery pack was exposed to air. A 0.5 ohm resistor was connected with the 2 cells and the resistor was immersed into NOVEC 71IPA heat-transfer medium. The heat power from the resistor was calculated as approximately 87 W. FIG. 6 displays the temperature rise of the cell and resistor after the switch was turned on. The cell temperature slightly increased from 27° C. to 37° C. The resistor temperature, however, quickly increased from room temperature to 50° C. within 20 seconds. The resistor temperature then slowly increased to 58° C. in 400 seconds. The NOVEC 71IPA has a boiling temperature around 54° C. and the heat generated from resistor was quickly transferred by evaporating the heat transfer medium.

A number of embodiments of the invention have been described. Nevertheless, it will be understood that various modifications may be made without departing from the spirit and scope of the invention. Accordingly, other embodiments are within the scope of the following claims.

What is claimed is:

1. A passive thermal management system for electrochemical cells comprising:
a nonaqueous heat-transfer medium;
a container having an inside and an outside, wherein the inside holds the heat-transfer medium; and
at least one or more electrochemical cells at least partially immersed in the medium.

2. The system according to claim 1 wherein the heat-transfer medium has a boiling point less than 80° C.

3. The system according to claim 2 wherein the heat-transfer medium comprises a fluorinated carbon fluid, optionally wherein the fluid is nonflammable.

4. The system according to claim 3 wherein the fluorinated carbon fluid comprises a hydrofluoroether.

5. The system according to claim 1 wherein the container comprises a vent.

6. The system according to claim 5 wherein the inside of the container is at substantially atmospheric pressure.

7. The system according to claim 6 wherein the container comprises a condensing surface.

8. The system according to claim 1 further comprising a condenser.

9. A passive thermal management system for electrochemical cells according to claim 1 wherein the heat transfer medium comprises one or more hydrofluoroethers.

10. The system according to claim 9 wherein the hydrofluoroethers have a boiling point of less than 80° C.

11. The system according to claim 9 wherein the container comprises a vent.

12. The system according to claim 11 wherein the cells are substantially submersed in the medium.

13. The system according to claim 9 further comprising a condenser.

14. The system according to claim 1 wherein the one or more electrochemical cells comprises a lithium-ion cell.

15. A passive thermal management system for electrochemical cells comprising:
a heat-transfer fluid;
one or more electrochemical cells; and
a heat exchanger at least partially filled with the heat-transfer fluid,
wherein at least one cell is in thermal contact with the heat exchanger.

16. The system according to claim 15 wherein the fluid is nonaqueous.

17. The system according to claim 16 wherein the fluid comprises a hydrofluoroether.

18. The system according to claim 15 further comprising:
a container; and
a nonaqueous heat-transfer medium,
wherein the container is at least partially filled with the medium, wherein at least one of the cells is at least partially immersed in the medium, and wherein the medium is in thermal contact with the heat exchanger.

19. The system according to claim 18 wherein the medium comprises a hydrofluoroether.

20. A method for passive thermal management of electrochemical cells comprising:
providing a container at least partially filled with a thermal transfer medium;
partially immersing at least one electrochemical cell in the medium;
charging or discharging the cell to produce a heated cell;
transferring heat from the heated cell to the medium; and
vaporizing medium using the heat from the heated cell.
